(19) United States
(12) Patent Application Publication
(10) Pub. No.: US 2019/0104488 A1
(43) Pub. Date: Apr. 4, 2019

(54) TRANSMIT SIGNAL SYNCHRONIZATION IN TWO CHANNELS DEDICATED SHORT RANGE COMMUNICATIONS SYSTEM

(71) Applicant: Panasonic Automotive Systems Company of America, Division of Panasonic Corporation of North America, Peachtree City, GA (US)

(72) Inventors: SAMEH WILLIAM TAWADROUS, SENOIA, GA (US); HANS A. TROEMEL, JR., SHARPSBURG, GA (US)

(73) Assignee: Panasonic Automotive Systems Company of America, Division of Panasonic Corporation of North America

(21) Appl. No.: 16/149,749

(22) Filed: Oct. 2, 2018

Related U.S. Application Data
(60) Provisional application No. 62/567,980, filed on Oct. 4, 2017.

(51) Int. Cl. H04W 56/00; H04W 4/80; H04W 4/44

(52) U.S. Cl. CPC H04W 56/001; H04W 4/44; H04W 4/80

(57) ABSTRACT

A dedicated short range communications (DSRC) unit includes a DSRC radio communicatively coupled to each of a first radio frequency transmitter and a second radio frequency transmitter. The DSRC radio sends a first radio signal to the first radio frequency transmitter such that the first radio frequency transmitter transmits the first radio signal. The DSRC radio sends a second radio signal to the second radio frequency transmitter such that the second radio frequency transmitter transmits the second radio signal. The DSRC radio produces a control signal that causes only one of the first radio frequency transmitter and the second radio frequency transmitter to transmit its respective radio signal at any point in time.

### CROSS-REFERENCE TO RELATED APPLICATION

This application claims benefit of U.S. Provisional Application No. 62/567,980 filed on Oct. 4, 2017, which the disclosure of which is hereby incorporated by reference in its entirety for all purposes.

### FIELD OF THE INVENTION

The disclosure relates to a dedicated short range communications system for a motor vehicle.

### BACKGROUND OF THE INVENTION

Dedicated short-range communications (DSRC) are one-way or two-way short-range to medium-range wireless communication channels specifically designed for automotive use and a corresponding set of protocols and standards. A road side unit (RSU) is the part of a DSRC system that is installed on the side of the road.

Road Side Equipment (RSE) includes the RSU in addition to other equipment to link the RSU to a backend network that may be hosted in the cloud. An on-board unit (OBU) is the part of a DSRC system that is installed in the moving vehicle.

A problem is that excessive heat is generated in the case of two full power channels transmitting at the same time. The power management circuit has to support double the amount of current, which makes the circuit implementation bigger in size and costlier. Also, two active high powered signals transmitting at the same time generates intermodulation signals that can negatively affect the receiver chain within the device.

FIG. 1 illustrates a vehicular DSRC system 100 of the prior art, including a DSRC unit 102 in RSE and antennae 104, 106. DSRC unit 102 includes a two-channel DSRC radio 108, a first transmitter 110, a first receiver 112, a second transmitter 114, a second receiver 116, a first switch 118, and a second switch 120.

During use, switches 118, 120 may operate independently in controlling whether antennae 104, 106 are transmitting or receiving at any given time. That is, switch 118 may control whether transmitter 110 or receiver 112 is active; and switch 120 may control whether transmitter 114 or receiver 116 is active. As described above, problems may occur when both channels, i.e., both transmitters 110, 114, are active and transmitting at the same time.

### SUMMARY

In a DSRC system that supports two active simultaneous channels, the present invention may enable the transmission of signals to be timed such that only one channel is transmitting while the channel is receiving.

In one embodiment, the invention comprises a dedicated short range communications (DSRC) unit including a DSRC radio communicatively coupled to each of a first radio frequency transmitter and a second radio frequency transmitter. The DSRC radio sends a first radio signal to the first radio frequency transmitter such that the first radio frequency transmitter transmits the first radio signal. The DSRC radio sends a second radio signal to the second radio frequency transmitter such that the second radio frequency transmitter transmits the second radio signal. The DSRC radio produces a control signal that causes only one of the first radio frequency transmitter and the second radio frequency transmitter to transmit its respective radio signal at any point in time.

In another embodiment, the invention comprises a method of operating a dedicated short range communications (DSRC) unit, including communicatively coupling a DSRC radio to each of a first radio frequency transmitter and a second radio frequency transmitter. A first radio signal is sent from the DSRC radio to the first radio frequency transmitter such that the first radio frequency transmitter transmits the first radio signal. A second radio signal is sent from the DSRC to the second radio frequency transmitter such that the second radio frequency transmitter transmits the second radio signal. A control signal is produced that prevents the first radio frequency transmitter and the second radio frequency transmitter from transmitting their respective radio signals at any same point in time.

In yet another embodiment, the invention includes a dedicated short range communications (DSRC) unit, including a first switch selectively interconnecting a first radio frequency transmitter and a first antenna. A second switch selectively interconnects the second radio frequency transmitter and a second antenna. A DSRC radio is communicatively coupled to each of the first radio frequency transmitter and the second radio frequency transmitter. The DSRC radio sends a first radio signal to the first radio frequency transmitter such that the first radio frequency transmitter transmits the first radio signal, and sends a second radio signal to the second radio frequency transmitter such that the second radio frequency transmitter transmits the second radio signal. The DSRC radio produces a control signal received by and controlling the first switch and the second switch. The control signal allows only one of the first radio frequency transmitter and the second radio frequency transmitter to transmit its respective radio signal to its respective antenna at any point in time.

An advantage of the present invention is that it may reduce heat within the DSRC unit.

Another advantage is that only one active high powered signal is transmitted at any given time, which avoids intermodulation signals that can negatively affect the receiver chain within the device.

### BRIEF DESCRIPTION OF THE DRAWINGS

A better understanding of the present invention will be had upon reference to the following description in conjunction with the accompanying drawings.

FIG. 1 is a block diagram of one embodiment of a vehicular DSRC system of the prior art.

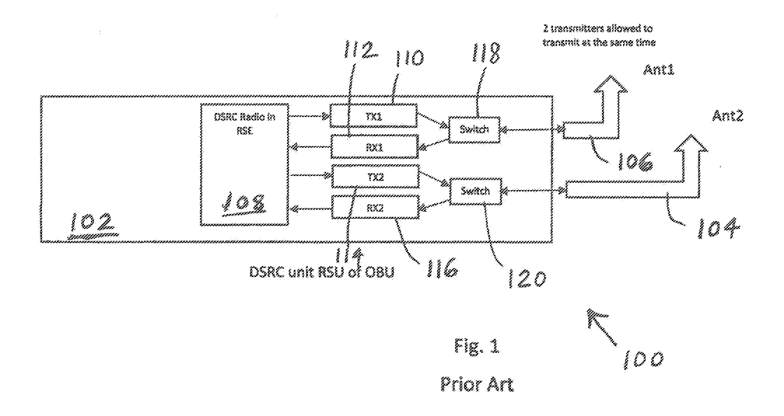

FIG. 2 is a block diagram of one embodiment of a vehicular DSRC system of the present invention.

FIG. 3 is a flow chart of one embodiment of a method of the present invention for operating a dedicated short range communications (DSRC) unit.

### DETAILED DESCRIPTION OF THE PREFERRED EMBODIMENTS

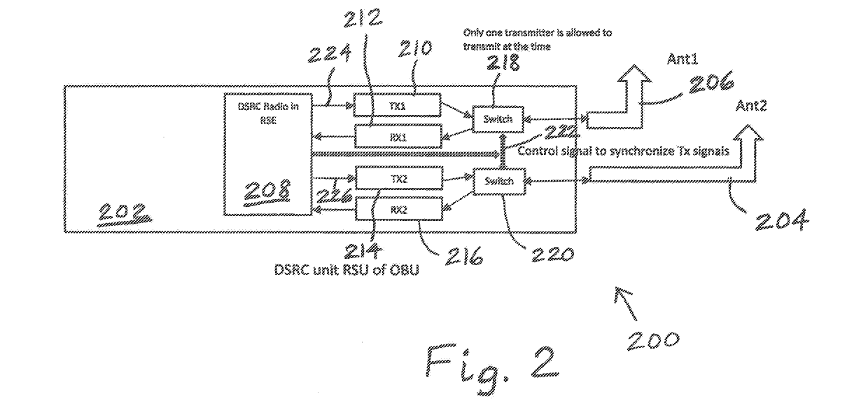

FIG. 2 illustrates one embodiment of a vehicular DSRC system 200 of the present invention for installation in a motor vehicle. System 200 includes a DSRC unit 202 in RSE and antennae 204, 206. DSRC unit 202 includes a two-channel DSRC radio 208, a first transmitter 210, a first receiver 212, a second transmitter 214, a second receiver 216, a first switch 218, and a second switch 220. A novel feature of system 200 is that DSRC radio 208 is communicatively coupled to switches 218, 220, and may transmit control signals to switches 218, 220, as indicated at 222, in order to synchronize transmission of signals from transmitters 210, 214. For example, control signals 222 may allow only one of switches 218, 220 to interconnect its respective transmitter to its respective antenna and any particular point in time. Thus, only one of transmitters 210, 214 may be allowed to transmit at a time.

During use, DSRC radio 208 sends radio signals 224, 226 to transmitters 210, 214, respectively. Switches 218, 220 may operate under the control of DSRC radio 208 such that radio 208 determines whether each of antennae 204, 206 is individually transmitting or receiving at any given time. That is, through switches 118, 120, DSRC radio 208 may control whether transmitter 110 or receiver 112 is active, and whether transmitter 114 or receiver 116 is active. As described above, through control of switches 118, 120, DSRC radio 208 may ensure that only one channel, i.e., only one of transmitters 110, 114, is active and transmitting at any particular point in time.

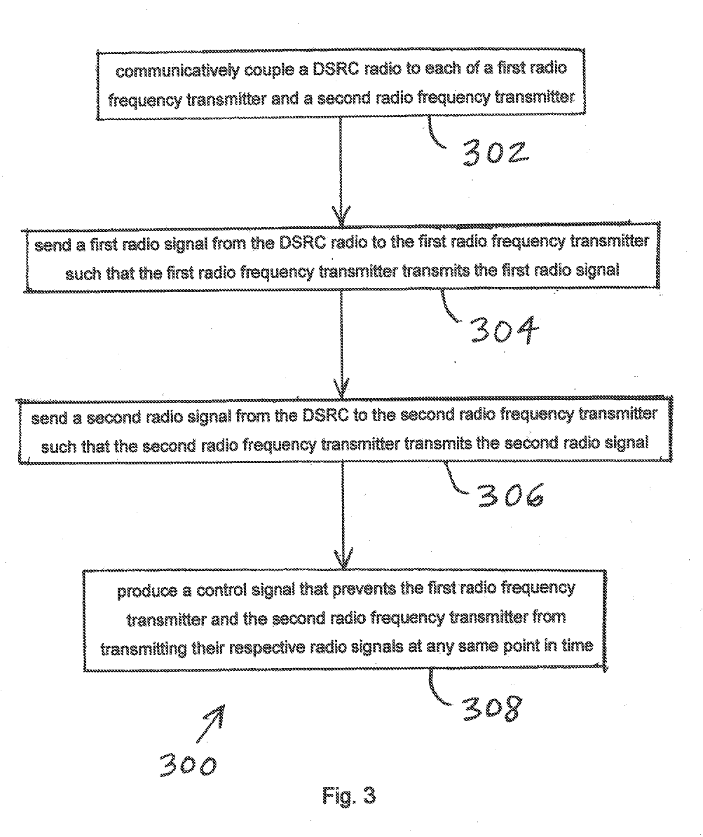

FIG. 3 illustrates one embodiment of a method 300 of the present invention for operating a dedicated short range communications (DSRC) unit. In a first step 302, a DSRC radio is communicatively coupled to each of a first radio frequency transmitter and a second radio frequency transmitter. For example, two-channel DSRC radio 208 is communicatively coupled to each of first transmitter 210 and second transmitter 214.

Next, in step 304, a first radio signal is sent from the DSRC radio to the first radio frequency transmitter such that the first radio frequency transmitter transmits the first radio signal. For example, DSRC radio 208 sends radio signal 224 to transmitter 210, and transmitter 210 transmits radio signal 224 in turn.

In a next step 306, a second radio signal is sent from the DSRC to the second radio frequency transmitter such that the second radio frequency transmitter transmits the second radio signal. For example, DSRC radio 208 sends radio signal 226 to transmitter 214, and transmitter 214 transmits radio signal 226 in turn.

In a final step 308, a control signal is produced that prevents the first radio frequency transmitter and the second radio frequency transmitter from transmitting their respective radio signals at any same point in time. For example, DSRC radio 208 may transmit control signals to switches 218, 220, as indicated at 222, in order to synchronize transmission of signals from transmitters 210, 214. Control signals 222 may allow only one of switches 218, 220 to interconnect its respective transmitter to its respective antenna and any particular point in time. Thus, only one of transmitters 210, 214 may be allowed to transmit at a time.

Embodiments of the invention have been described as being applied to DSRC systems that support two active channels at the same time. However, other embodiments of the invention may include reducing the transmitted power which yields reduced performance and coverage area.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detail description is given primarily for clearness of understanding and no unnecessary limitations are to be understood therefrom for modifications can be made by those skilled in the art upon reading this disclosure and may be made without departing from the spirit of the invention.

What is claimed is:

1. A dedicated short range communications (DSRC) unit, comprising:
a first radio frequency transmitter;
a second radio frequency transmitter; and
a DSRC radio communicatively coupled to each of the first radio frequency transmitter and the second radio frequency transmitter, the DSRC radio being configured to:
send a first radio signal to the first radio frequency transmitter such that the first radio frequency transmitter transmits the first radio signal;
send a second radio signal to the second radio frequency transmitter such that the second radio frequency transmitter transmits the second radio signal; and
produce a control signal that causes only one of the first radio frequency transmitter and the second radio frequency transmitter to transmit its respective radio signal at any point in time.

2. The DSRC unit of claim 1 further comprising:
a first switch selectively interconnecting the first radio frequency transmitter and a first antenna; and
a second switch selectively interconnecting the second radio frequency transmitter and a second antenna.

3. The DSRC unit of claim 2 wherein the control signal produced by the DSRC radio is received by and controls the first switch and the second switch.

4. The DSRC unit of claim 2 further comprising:
a first radio frequency receiver communicatively coupled to the DSRC radio; and
a second radio frequency receiver communicatively coupled to the DSRC radio.

5. The DSRC unit of claim 4 wherein the first switch selectively interconnects the first radio frequency receiver and the first antenna, and the second switch selectively interconnects the second radio frequency receiver and the second antenna.

6. The DSRC unit of claim 1 wherein the DSRC radio is included in Road Side Equipment.

7. A method of operating a dedicated short range communications (DSRC) unit, the method comprising:
communicatively coupling a DSRC radio to each of a first radio frequency transmitter and a second radio frequency transmitter;
sending a first radio signal from the DSRC radio to the first radio frequency transmitter such that the first radio frequency transmitter transmits the first radio signal;
sending a second radio signal from the DSRC to the second radio frequency transmitter such that the second radio frequency transmitter transmits the second radio signal; and
producing a control signal that prevents the first radio frequency transmitter and the second radio frequency transmitter from transmitting their respective radio signals at any same point in time.

8. The method of claim 7 further comprising:
providing a first switch selectively interconnecting the first radio frequency transmitter and a first antenna; and
providing a second switch selectively interconnecting the second radio frequency transmitter and a second antenna.

9. The method of claim 8 wherein the control signal produced by the DSRC radio is received by and controls the first switch and the second switch.

10. The method of claim 8 further comprising:
communicatively coupling a first radio frequency receiver to the DSRC radio; and
communicatively coupling a second radio frequency receiver to the DSRC radio.

11. The method of claim 10 wherein the first switch selectively interconnects the first radio frequency receiver and the first antenna, and the second switch selectively interconnects the second radio frequency receiver and the second antenna.

12. The method of claim 7 wherein the DSRC radio is included in Road Side Equipment.

13. The method of claim 7 wherein the control signal reduces power levels at which the first radio frequency transmitter and the second radio frequency transmitter transmit their respective radio signals.

14. A dedicated short range communications (DSRC) unit, comprising:
a first radio frequency transmitter;
a second radio frequency transmitter;
a first switch selectively interconnecting the first radio frequency transmitter and a first antenna;
a second switch selectively interconnecting the second radio frequency transmitter and a second antenna; and
a DSRC radio communicatively coupled to each of the first radio frequency transmitter and the second radio frequency transmitter, the DSRC radio being configured to:
send a first radio signal to the first radio frequency transmitter such that the first radio frequency transmitter transmits the first radio signal;
send a second radio signal to the second radio frequency transmitter such that the second radio frequency transmitter transmits the second radio signal; and
produce a control signal received by and controlling the first switch and the second switch, the control signal allowing only one of the first radio frequency transmitter and the second radio frequency transmitter to transmit its respective radio signal to its respective antenna at any point in time.

15. The DSRC unit of claim 14 further comprising:
a first radio frequency receiver communicatively coupled to the DSRC radio; and
a second radio frequency receiver communicatively coupled to the DSRC radio.

16. The DSRC unit of claim 15 wherein the first radio frequency receiver and the second radio frequency receiver are configured to simultaneously transmit respective radio signals to the DSRC radio.

17. The DSRC unit of claim 15 wherein the first switch selectively interconnects the first radio frequency receiver and the first antenna, and the second switch selectively interconnects the second radio frequency receiver and the second antenna.

18. The DSRC unit of claim 14 wherein the DSRC radio is included in Road Side Equipment.
